(19) United States
(12) Patent Application Publication
(10) Pub. No.: US 2015/0139873 A1
(43) Pub. Date: May 21, 2015

(54) METHOD FOR THE EXTRACTION OF VANADIUMPENTOXIDE, V2O5, FROM A SOURCE CONTAINING VANADIUM

(71) Applicant: JERNKONTORET, Stockholm (SE)

(72) Inventors: Seshadri Seetharaman, Taby (SE); Sridhar Seetharaman, Pittsburg, PA (US); Lidong Teng, Vasteras (SE); Piotr Scheller, Radebeul (DE)

(21) Appl. No.: 14/412,134

(22) PCT Filed: Jul. 3, 2013
(86) PCT No.: PCT/SE2013/050852

§ 371 Date: Dec. 30, 2014

(30) Foreign Application Priority Data
Jul. 4, 2012 (SE) 1250767-9

(51) Int. Cl. C01G 31/02; C22B 34/22; C22B 1/02

(52) U.S. Cl. CPC C01G 31/02; C22B 1/02; C22B 34/22; C22B 34/225
USPC 423/62; 423/594.17

(57) ABSTRACT

The invention relates to a method for the extraction of vanadium from various sources in the form of vanadiumpentoxide, V₂O₅, from a source containing vanadium. The method includes the steps of: providing a source of V₂O₅, heating the source to a temperature of at least 1000° C., evaporating V₂O₅ from the heated source and recovering the evaporated V₂O₅.

### TECHNICAL FIELD

The invention relates to a method for the extraction of vanadiumpentoxide, V₂O₅, from a source containing vanadium.

### BACKGROUND ART

Vanadiumpentoxide, V₂O₅, is mainly used as a catalyst in the chemical industry and for the production of ferrovanadium.

In the past there has been a great interest to recover vanadium or vanadium oxide from different sources. In particular, different routes for selective pre-oxidation of vanadium from raw iron has received much attention and e.g. EP 235 291, EP 134 351, U.S. Pat. No. 4,071,355 and GB 1 281 203 discloses recovery of vanadium oxide from molten metal.

### SUMMARY OF THE INVENTION

The general object of the present invention is to provide an alternative production route for the extraction of vanadium from various sources in the form of vanadium pentoxide. This and other objects are achieved by means of a method as defined in claim 1. Preferred embodiments of the invention are specified in the dependent claims.

The present inventors have found that it is possible to extract vanadium in the form of in the form of vanadium pentoxide, V₂O₅, by evaporation of this oxide. To be specific, the claimed method includes the steps of:
providing a source containing vanadium,
if necessary, converting at least part of the vanadium in said source to V₂O₅, thereby providing a source of V₂O₅,
heating the source to a temperature of at least 1000° C.,
evaporating V₂O₅ from the heated source and
recovering the evaporated V₂O₅.

The invention is defined in the claims.

### DETAILED DESCRIPTION

Basically any vanadium containing source can be used in the claimed method. However from a practical point of view the vanadium containing source is suitably selected from the group of: ore, slag, ash and V₂O₅ formed by roasting vanadium-sulphide from spent petroleum refining catalysts since these are the most important sources. If the vanadium in said source is not in the form of vanadium pentoxide, V₂O₅, then it is necessary to convert at least part of the vanadium to V₂O₅ In most cases all vanadium is converted to V₂O₅ This is done by roasting the sulphide or by oxidation of the lower oxides (V^{3+/}V⁴⁺) to pentoxide (V⁵⁺).

Preferably the ore is selected from the iron sands, magnetite, hematite, titani-ferrous magnetite and vanadium-titanium magnetite; the slag is selected from converter slag, submerged arc furnace slag, ladle slag and slag obtained by selective oxidation of vanadium from raw iron; and the ash is selected from petroleum coke ash, in particular fly ash and boiler ash.

The evaporation is promoted by an oxidizing atmosphere and the evaporation increases with increasing partial pressure of oxygen such that oxygen-enriched air and pure oxygen results in higher evaporation ability than in air.

Evaporation can take place from a solid and/or a liquid V₂O₅—containing source. A major source of supply is slag from the steel industry. In this case the slag should be liquid and an oxidizing gas is preferably blown into or through the liquid slag bath held at 1200° C. to 1900° C., preferably 1450° C. to 1700° C. The slag normally comprises at least three of the following components CaO, MgO, MnO, SiO₂, TiO₂, FeOₓ and VOₓ, wherein x indicates that the oxides need not be stoichiometric and that more than one valence state may present. Vanadium can have three valence states: V³⁺, V⁴⁺ and V⁵⁺. High slag basicities stabilizes higher vanadium oxidation states such that one should expect V⁴⁺/V⁵⁺ to be the predominant redox-pair.

Ash, such as petroleum coke ash can optionally be mixed with one or more of components selected from CaO, MgO, MnO, SiO₂, TiO₂, Al₂O₃ and FeOₓ and subjected to at least partly melting wherein the ash/slag mixture is liquid or solid-liquid mixture and held at 1200° C. to 1900° C., preferably 1450° C. to 1700° C. and wherein oxygen or oxygen enriched air is blown through the slag bath for generation and evaporation of V₂O₅.

Evaporation of V₂O₅ from a solid vanadium-containing source is a feasible alternative, in particular when using ore. The Swedish magnetite ore for instance contains about 1.5% V. In one preferred embodiment magnetite ore is roasted to hematite at a temperature in the range of 1100-1300° C. by using oxygen as a carrier gas in a fluidized bed reactor. In this case, the temperature should be adjusted to lay just under the softening temperature of the vanadium containing iron ore in order to avoid problems with sticking. As an alternative to oxygen, air or oxygen enriched air containing 22-99% oxygen may be used.

As a precursor for the source of V₂O₅, it is possible use vanadium-sulphide, V₃ S₄, from spent catalysts. V₃5₄ is deposited in high amounts on petroleum refining catalysts for desulphurization. When these catalysts are spent said sulphide can be converted to oxide by a roasting treatment and thus provide a source of V₂O₅. The roasting can be performed by conventional methods known in the art. The roasting of V₃ S₄ and the evaporation of V₂O₅ may be performed in a single step by oxidizing the V₃ S₄ at temperatures of at least 1000° C., so that V₂O₅ is evaporated as it is formed.

The evaporated V₂O₅ is recovered by subjecting the V₂O₅ containing gas to condensation. Any type of condensation can be used. A conventional cold trap may be used.

### EXAMPLE 1

Vanadium containing slag from the production of high alloyed tool steels was treated according to the invention. The slag had the following composition in weight percent; 5% V₂O₅, 37.5% CaO, 20% FeO, and 37.5% SiO₂.

The slag was split in two samples. The samples were heated in air under laboratory conditions in a platinum crucible at 1853K respectively 1873K during 120 minutes. The exit gas from the furnace was cooled, filtered and formed oxide particles were collected. For the sample heated to 1823K 80% by weight of V₂O₅ was recovered. For the sample heated to 1873K 90% by weight of V₂O₅ was recovered. The purity of the vanadium pentoxide was over 95% by weight.

### EXAMPLE 2

Pet coke slag was heated in an alumina crucible and melted in an electric arc furnace. The slag had the following composition expressed in weight percent; 42.8% V₂O₃, 12.5% CaO, 10.7% FeO, 7.4% Al₂O₃ and 26.6% SiO₂.

The slag was heated in the furnace from room temperature to a temperature of 1480° C. Air was blown into the liquid slag. This resulted in an oxidation of FeO to Fe₂O₃ and of V₂O₃ to V₂O₅. The slag was kept liquid under oxidizing conditions for 400 minutes. The reaction was found to be faster with oxygen blowing. The exit gas was condensed in a cold trap.

The amount of V₂O₅ found in the cold trap was equivalent to 92% by weight of the original amount in the pet coke slag. The purity of the vanadium pentoxide was over 98% by weight.

### EXAMPLE 3

A Swedish magnetite ore containing 95% Fe₃O₄, 1.5% V₂O₅ and the residual mainly SiO₂ was heated in an alumina crucible for two hours at 1623K under a flow of oxygen enriched air containing 50% oxygen. The content of V₂O₅ in the magnetite ore decreased after 2 hours processing from 1.5% to 0.3%. The purity of the vanadium pentoxide was 95% by weight.

1. A method for the extraction of vanadium pentoxide, V₂O₅, from a source containing V₂O₅, the method comprises the steps of:
providing a source containing vanadium,
if necessary, converting at least part of the vanadium in said source to V₂O₅, thereby providing a source of V₂O₅,
heating the source of V₂O₅ to a temperature of at least 1000° C.,
evaporating V₂O₅ from the heated source and
recovering the evaporated V₂O₅.

2-15. (canceled)

16. The method according to claim 1, wherein the vanadium containing source is selected from the group of: ore, slag, ash and vanadium-sulphide.

17. The method according to claim 1, wherein the vanadium containing source is from spent petroleum refining catalysts.

18. The method according to claim 16, wherein the ore is selected from the iron sands, magnetite, hematite, titani-ferrous magnetite and vanadium-titanium magnetite; the slag is selected from converter slag, submerged arc furnace slag, ladle slag and slag obtained by selective oxidation of vanadium from raw iron; and the ash is selected from petroleum coke ash.

19. The method according to claim 16, wherein the ash is selected from fly ash and boiler ash.

20. The method according to claim 1, wherein the evaporation is carried out by the use of a gas.

21. The method according to claim 1, wherein the evaporation is carried out by the use of air or oxygen enriched air containing 22-99% oxygen.

22. The method according to claim 1, wherein the evaporation is carried out by the use of only oxygen.

23. The method according to claim 20, wherein the gas is blown into or through a liquid bath containing the source of V₂O₅.

24. The method according to claim 23, wherein the liquid bath comprises a slag bath and the temperature of the slag is 1200° C. to 1900° C.

25. The method according to claim 23, wherein the liquid bath comprises a slag bath and the temperature of the slag is 1450° C. to 1700° C.

26. The method according to claim 24, wherein the slag comprises at least three of the following components CaO, MgO, MnO, SiO₂, TiO₂, Al₂O₃, FeOₓ and VOₓ.

27. The method according to claim 21, wherein the source of V₂O₅ is in the solid state and the evaporation is made by the use of a gas as a carrier medium.

28. The method according to claim 27, wherein the gas is air, oxygen enriched air containing 22-99% oxygen or pure oxygen.

29. The method according to claim 27, wherein the evaporation is made in a fluidized bed reactor.

30. The method according to claim 29, wherein the evaporation is made at a temperature of 1100° C. to 1300° C.

31. The method according to claim 29, wherein the source of vanadium is an iron ore which is roasted to hematite during the treatment in the fluidized bed reactor.

32. The method according to claim 29, wherein the source of vanadium is a magnetite ore which is roasted to hematite during the treatment in the fluidized bed reactor.

33. The method according to claim 16, wherein the source of V₂O₅ is V₂O₅ formed by roasting vanadium-sulphide, V₃5₄, from spent petroleum refining catalysts and wherein the roasting is performed as a separate step prior to the evaporation step.

34. The method according to claim 16, wherein the slag is selected from converter slag and slag obtained by selective oxidation of vanadium from raw iron, wherein the slag is liquid and held at 1450° C. to 1700° C. and wherein oxygen or oxygen enriched air is blown through the slag bath.

35. The method according to claim 16, wherein the ash is petroleum coke ash, optionally mixed with one or more of components selected from CaO, MgO, MnO, SiO₂, TiO₂, Al₂O₃ and FeOₓ, wherein the ash/slag mixture is liquid and held at 1200° C. to 1900° C., preferably 1450° C. to 1700° C. and wherein oxygen or oxygen enriched air is blown through the slag bath.

36. The method according to claim 1, wherein the evaporated V₂O₅ is recovered by subjecting the V₂O₅ containing gas to condensation

37. The method according to claim 1, wherein the V₂O₅ containing gas is fed to a cold trap for recovery of solid V₂O₅.
